(19) United States
(12) Patent Application Publication
(10) Pub. No.: US 2009/0030789 A1
(43) Pub. Date: Jan. 29, 2009

(54) System and Method for Locating Rewards and Discounts in E-Commerce

(75) Inventor: Alex Mashinsky, Memphis, TN (US)

Correspondence Address: COHEN, PONTANI, LIEBERMAN & PAVANE LLP, 551 FIFTH AVENUE, SUITE 1210, NEW YORK, NY, 10176, US

(73) Assignee: Governing Dynamics LLC, New York, NY (US)

(21) Appl. No.: 12/086,723

(22) PCT Filed: Jan. 8, 2007
(86) PCT No.: PCT/US2007/000465

§ 371 Date: Jun. 18, 2008

Related U.S. Application Data
(60) Provisional application No. 60/757,075, filed on Jan. 6, 2006.

(51) Int. Cl. G06Q 30/00

(52) U.S. Cl. 705/14

(57) ABSTRACT

A centralized system that acts on behalf of multiple merchants, wherein a controlled and manageable way to monitor and issue rewards, discounts, coupons and payments to customers is provided. The system performs calculations to allocate discounts and rewards for individual buyers, designate final prices for individual buyers, and provide fast and efficient settlements of outstanding balances.

### RELATED APPLICATIONS

This application claims priority from U.S. Provisional Patent Application Ser. No. 60/757,075 which was filed on Jan. 6, 2006.

### BACKGROUND OF THE INVENTION

1. Field of the Invention

The present invention generally relates to the field of remote accessing and, more particularly, to e-commerce and a system and method for assisting users engaged in making purchases over the Internet, while locating and taking advantage of special rates and promotions that may be offered to specific users and/or under specific circumstances.

2. Description of the Related Art

Web search and portal companies, such as AOL®, E-bay®, Google®, Yahoo® and Microsoft®, represent the top search, aggregation and syndication market share leaders within the Internet. Generally, these companies provide a particular buyer with a method for performing searches, where the buyer accesses a web site and receives search results and listings of offers from vendors/sellers in a more or less indiscriminate manner. Here, there is no specific targeting of buyers, but rather the same search results and same ads are provided indiscriminately to anyone accessing specific sites, and the ads contain information that relates only to what the vendor/seller intends to sell or offer to the intended recipient of the ad. Conventional search engines do not store a user's search data for future use nor do they notify the buyer of new matches.

Buyers are not provided with any specially tailored or customized leverage in obtaining the goods and services they desire and there is no way for the buyer to negotiate group discounts by aggregating their requests based on pre-existing pools of requests or newly created pools. That is, the buyers are unable to present their requests to vendors directly or find each other by means of data mining techniques. Moreover, there is no dynamic tracking or solicitation to enable matching of supply and demand between buyers and vendors/sellers, no individualized and specific interactions between groups of buyers and sellers, and no efficient price discovery for specific goods or services. Currently, the ability of sellers/vendors to analyze and meet the demands of forecasts and market trends lacks in accuracy.

### SUMMARY OF THE INVENTION

The invention is directed to a system and method for assisting users engaged in making purchases over the Internet to locate and take advantage of special rates and promotions that may be offered to specific users under specific circumstances. In accordance with the invention, the system provides a centralized, efficient way to obtain a desired product within a specified period of time. Alternatively, when time is not of the essence, a wish list of a buyer, which is created and stored into the system once a user enters the website, is maintained into the system until the desired product and/or set of conditions become available. The disclosed system combines the ability to match buyers and sellers, identify and match their respective profiles, and provides promotional items which were pre-approved for such sellers or institute a process by which the seller is motivated to offer certain rewards to specific buyers who fulfill certain criteria or obligations. In addition, the system monitors and records the actions and offers from multiple sources, collects transaction information from the sellers and issues rewards, promotions and coupons to the buyers. In addition, the present invention provides buyers with greater leverage in obtaining desired goods and services by allowing the buyers to present their requests to vendors or sellers directly or by way of data mining capabilities. As a result, This allows for a dynamic match of supply and demand is achieved and more individualized and specific interactions between different buyers and sellers is permitted, contributing to higher satisfaction for both the buyer and seller or vendors, better price discovery and improved ability for sellers or vendors to analyze and meet the demands of forecasts and market trends.

The system comprises a portal that is accessed via the web or Internet. In alternative embodiments, the system comprises a plug-in software module, working with an aggregating central system, i.e., a system match module, which forms part of another program, such as browser or application specific software. Upon the occurrence of a certain action by the user, the software module may initiate a search or retrieve offers from sellers or merchants and display such information to the user or place orders on behalf of a user.

The contemplated system provides a method of registering a buyer with a web site, while creating and storing a “buyer's wish list” in a database for each individual or buyer registered at the web site. If permitted to do so, the contemplated system may also collect data from buyers, which may provide context to the items requested by a buyer. Here, the wish list comprises items or areas of interest for each individual buyer. A buyer may browse and review other offers by sellers or vendors by searching through the site and may add himself as a potential buyer to an existing group of interest. Upon registering with the system, a buyer is provided with multiple options. In a first option, the buyer may fill out a form indicating items or areas of interest, which will be stored into their respective wish list. In a second option, the buyer may transfer pertinent information, such as browsing, purchase or transaction history from his own applications into the system match module, which will be stored into the buyer's wish list. Finally, the buyer may proceed with a search for a particular item or within a particular area, which is then automatically stored by the system into that buyer's wish list.

In addition to the foregoing options, the buyer may provide their consent to have their information loaded or stored in a common wish list database. In the contemplated embodiments, the wish lists contain information of immediate concern or information that relates to acquiring an item at some point in the future. Consequently, each time that the buyer performs a search regarding a particular item or a particular area of interest the information is stored into the buyer's wish list or the common wish list database.

The software module also includes data and “links” to specific sellers or vendors offering rewards and discounts which would match buyers' requests, links to third party providers, such as Amazon®, E-bay® or Priceline®, a repository of discounts and rewards available from certain vendors, as well as a vendor's wish list. Here, the wish list of the vendor comprises price and quantity limitations, such as packages of different items or quotes for lump sum promotions, which would be offered only if a predetermined quantity of a specific product would be sold to a specific group of buyers. Moreover, the software module also permits vendors or sellers to access the site and post their offers and rewards, and also stores information on the site.

The contemplated system dynamically informs both buyers and sellers or vendors of the availability of demands and offers, respectively, for certain items in association with predetermined discounts and rewards. In accordance with the contemplated embodiments, the system aggregates a group of buyers, who are interested in obtaining the same item while benefiting from a discount or reward, and matches the number of buyers to the number of items associated with a lump sum promotion that the vendor is willing to provide. For instance, e-bay may use such a method to entice sellers and buyers to create a match. In a hypothetical situation, 42 in TVs, which regularly would be sold for $3000 each, may be sold for much less, such as $2200 each, when a pool of buyers is created and 1000 TVs are sold within a short specified amount of time, such as 2 days. When requests for a 42 in TV are placed into the system, in accordance with the contemplated embodiments of the invention, a match is made with a manufacturer or seller of the particular product and feedback is sent to the buyer or buyers as to the conditions buyers have to meet in order to obtain the product. As a result, the buyers will receive the information that they may purchase the TV for $2200.00 if 1000 TVs are sold within 2 days. Consequently, in addition to the system aggregating buyers for the said item, buyers may actively act via social networks and/or other sites to recruit the additional number of buyers to meet the manufacturer or vendor's condition to obtain the TV for $2200.00. When the number of buyers' requests reaches a certain number, the system may also initiate dynamic advertising to assist in creating the pull of buyers necessary to meet the manufacturer's or vendor's condition.

The contemplated system of the invention utilizes data from the sellers or vendors to verify that specific purchases occurred prior to issuing payments to sellers. In the event that a refund for a purchase occurs, the system notifies the seller or a third party, and the buyer is then “marked” such that this buyer becomes excluded from receiving certain promotions or rewards. Alternatively, the rebate provided to the buyer is maintained in escrow for an extended period of time prior to being released to the buyer or it is credited against the buyer's account.

The system and method of the disclosed embodiments provides a centralized system that acts on behalf of multiple merchants and provides a controlled and manageable way to monitor and issue rewards, discounts, coupons and payments to customers. Moreover, the system performs calculations to allocate discounts and rewards for individual buyers, designate final prices for individual buyers, and provide fast and efficient settlements of outstanding balances.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The foregoing and other advantages and features of the invention will become more apparent from the detailed description of the preferred embodiments of the invention given below with reference to the accompanying drawings in which:

FIG. 1 is a schematic block diagram of the system in accordance with an embodiment of the invention; and

FIG. 2 is a schematic block diagram illustrating the system match module of FIG. 1;

FIG. 3 is an exemplary block diagram illustrating the interaction of the components of a system match module associated with providing coupons in accordance with the invention;

FIG. 4 is an exemplary block diagram illustrating the interaction of buyers and third party providers pursuant to placing orders for certain items; and

FIG. 5 is a flow chart illustrating the steps of the method of the invention associated with processing a transaction.

### DETAILED DESCRIPTION OF THE EXEMPLARY EMBODIMENTS

The invention is directed to a system and method for assisting users engaged in making purchases over the Internet to locate and take advantage of special rates and promotions that may be offered to specific users under specific circumstances. In accordance with the invention, the system provides a centralized, efficient way to obtain a desired product within a specified period of time. Alternatively, when time is not of the essence, a wish list of a buyer, which is created and stored into the system once a user enters the website, is maintained into the system until the desired product and/or set of conditions become available. The disclosed system combines the ability to match buyers and sellers, identify and match their respective profiles, and provides promotional items which were pre-approved for such sellers or institute a process by which the seller is motivated to offer certain rewards to specific buyers who fulfill certain criteria or obligations. In addition, the system monitors and records the actions and offers from multiple sources, collects transaction information from the sellers and issues rewards, promotions and coupons to the buyers. In addition, the present invention provides buyers with greater leverage in obtaining desired goods and services by allowing the buyers to present their requests to vendors or sellers directly or by way of data mining capabilities. As a result, This allows for a dynamic match of supply and demand is achieved and more individualized and specific interactions between different buyers and sellers is permitted, contributing to higher satisfaction for both the buyer and seller or vendors, better price discovery and improved ability for sellers or vendors to analyze and meet the demands of forecasts and market trends.

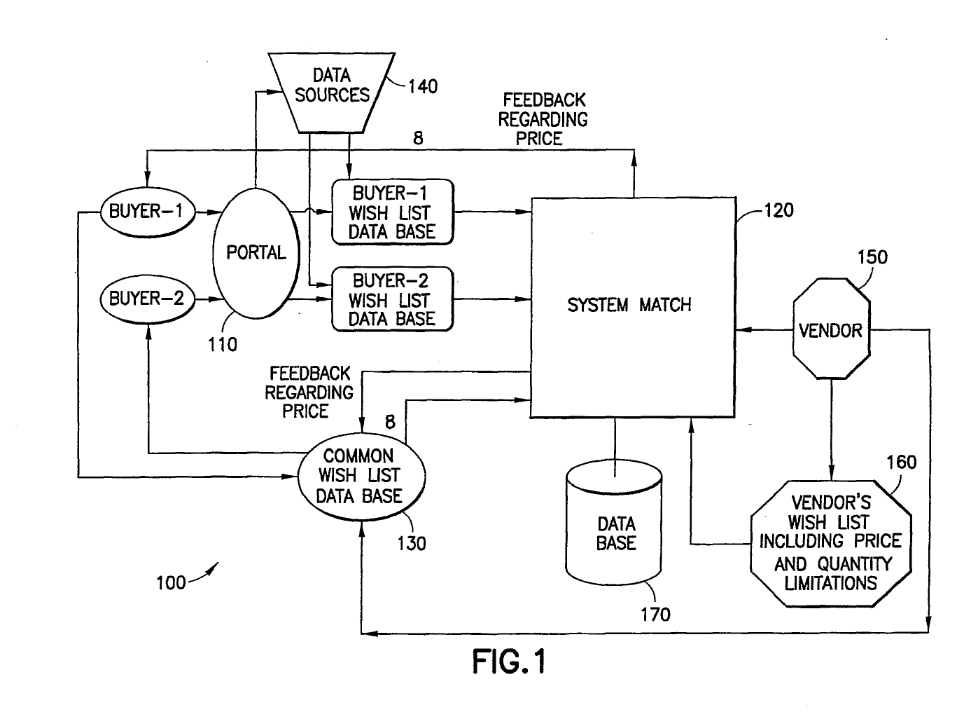

FIG. 1 is a schematic block diagram of the system 100 in accordance with an embodiment of the invention. With reference to FIG. 1, the system 100 comprises a portal 110 that is accessed via the web or Internet (not shown). A portal or gateway for a World Wide Web (WWW or Web) site is a major starting site for users when they get connected to the web or a site that users tend to visit frequently (i.e. an anchor site). There are general portals and specialized or niche portals. Some major general portals include Yahoo®, Excite®, Netscape®, Lycos, CNET, Microsoft Network and America Online's AOL.com. Examples of niche portals include Garden.com (for gardeners), Fool.com (for investors), and SearchNetworking.com (for network administrators).

A number of large access providers offer portals to the web for their own users. Most portals have adopted the Yahoo® style of content categories with a text-intensive, faster loading page that visitors find easy to use and revisit. Typical services offered by portal sites include a directory of Web sites, a facility to search for other sites, news, weather information, e-mail, stock quotes, phone and map information, and sometimes a community forum. In alternative embodiments, the system comprises an application that is located on at least one of a computer and a device that belongs to a user, such as personal digital assistant or a web enabled device, such as a mobile phone.

In certain embodiments of the invention, the system 100 comprises a plug-in software module, working with an aggregating central system, i.e., a system match module, which forms part of another program, such as browser or application specific software. Upon the occurrence of a certain action by the user, the software module may initiate a search or retrieve offers from sellers or merchants and display the retrieved information to the user or place orders on behalf of a user. For example, the software module may operate in conjunction with several parties and combine multiple revenue shares with a customer or may collect transaction fees from search engines, companies collecting usage information, distributors or resellers and manufacturers. In accordance with the contemplated embodiments, advertising promotions may be combined into a lump sum, which will be paid out only if a buyer has completed specific actions, such as place an order to purchase goods or services or complete a questionnaire.

The contemplated system provides a method of registering a buyer to the site, while creating and storing a “buyer's wish list” in a database for each individual registered at the site, such as wish list database 1 and wish list database 2 for buyer 1 and buyer 2, respectively. Here, the wish list comprises items or areas of interest for each individual buyer. With further reference to FIG. 1, upon registering with the system 100, a buyer is provided with multiple options. In a first option, the buyer may fill out a form indicating items or areas of interest, which will be stored into their respective wish list. In a second option, the buyer may transfer pertinent information, such as browsing history, financial transactions, inventory data, from his own applications into the system match module 120, which will be stored into the buyer's wish list. Finally, the buyer may proceed with a search for a particular item or within a particular area, which is then automatically stored by the system into that buyer's wish list. In addition to the foregoing options, the buyer may provide their consent to have their information loaded or stored as masked data in a common wish list database 130. In the contemplated embodiments, the wish lists contain information of immediate concern or information that relates to acquiring an item at some point in the future. Consequently, each time that the buyer performs a search regarding a particular item or a particular area of interest, the information is stored into the buyer's wish list or the common wish list database 130.

In accordance with the contemplated embodiments, data sources 140, such as browsing data, favorites, trading data and the like, are also loaded in the database associated with a respective buyer's wish list or the common wish list database 130 to enable individual searches or searches by way of data mining, respectively. The buyer is provided, either locally or through the system match module 120, with the ability to delete unwanted items from his wish list or to temporarily inactivate searches for unwanted items when these items are no longer of long-term interest or short term (i.e., current interest) to the buyer. Moreover, the buyers and sellers have the option to withdraw data from the system permanently.

The system match module 120 also includes “links” to specific sellers or vendors 150 offering rewards and discounts that would match buyers' requests, links to third party providers, such as Amazon®, E-bay® or Priceline®, a repository of discounts and rewards available from certain vendors, as well as a vendor's wish list 160. Here, the wish list of the vendor 160 comprises price and quantity limitations, such as packages of different items or quotes for lump sum promotions, which would be offered only if a predetermined quantity of a specific product would be sold to a specific buyer. In addition, the vendor 150 may access the system 100 directly or through the vendor wish list 160.

The contemplated system 100 also includes a repository of databases 170 or a means to connect to various third party providers. In addition, the system 100 dynamically informs both buyers and sellers or vendors 150 of the availability of demands and offers for certain items in association with predetermined discounts and rewards. In accordance with the contemplated embodiments, the system 100 aggregates a group of buyers, who are interested in obtaining the same item while benefiting from a discount or reward, and matches the number of buyers to the number of items associated with a lump sum promotion that the vendor 150 is willing to provide. In addition, the system 100 sends the identical information to vendors engaged in the same area of business. As a result, competition between competitors is encouraged, and buyers are offered a wider range of choices for the same or substantially similar items. For example, the aggregated requests of a pool of buyers for Mini Coopers are sent to BMW, but also to Mercedes-Benz, because Mercedes can also offer the same buyers the option of a package deal for Smart cars (a comparable small car to a Mini Cooper).

Moreover, when a buyer provides a request to purchase a specific item, the system 100 provides feedback to the buyer with respect to whether a vendor 150 is willing to provide the specific item or service under certain conditions. In response, the buyer can modify their request in order to qualify for such a reward program. In addition, buyers receive feedback from the system match module 120 related to the current possibility to acquire specific items based on a quoted price range. If the quoted price falls below a predetermined sale price set by the vendor 150 for a particular item, then the buyer is informed that the item is not available for the quoted price at this specific moment in time. However, the item will then be saved into the wish list of the buyer, until a match between the prices that the buyer is willing to pay for the item may subsequently become available. Therefore, the system 120 provides the buyer with the ability to modify his request for that particular item by quoting a different price or opt to receive information at a later time that it may become available when it matches the parameters defines in the wish list of the buyer.

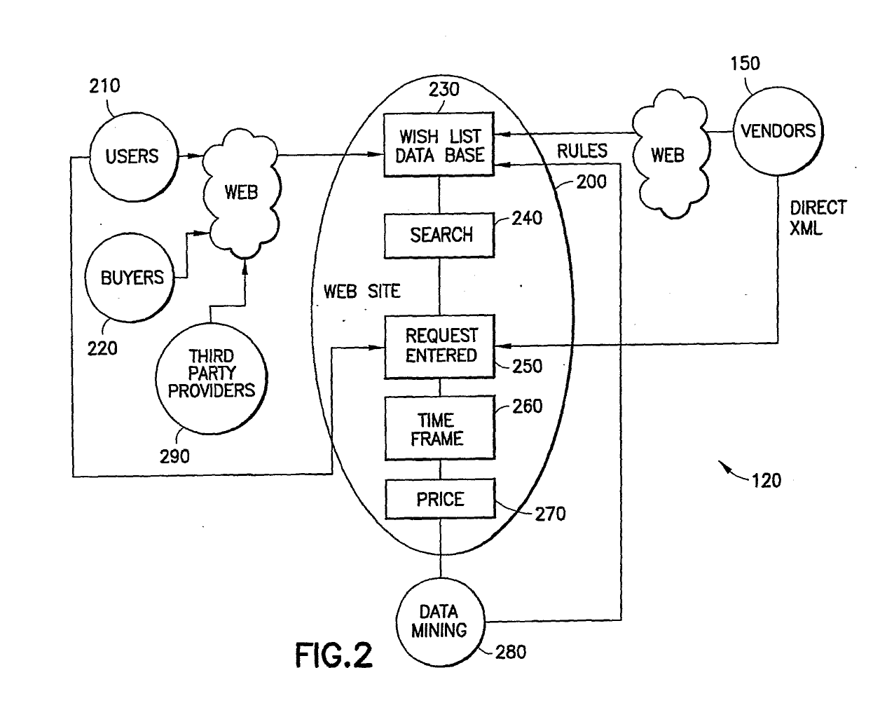

In accordance with the contemplated embodiments, pursuant to dynamic interaction between buyers and vendors, when discount or reward programs are released and/or provided by a vendor 150, the system 100 sends the information to the wish list of buyers that contain requests for a specific item or an area of an industry related to items on their wish list or executes on the transaction if a limit order with payment guarantee was submitted. Naturally, it will be appreciated that the information can also be sent to the common wish list database 130. Here, the rewards and discounts are stored in the database 170 for access by new buyers and third party web providers (FIG. 2). In another embodiment of the invention, sellers or vendors are permitted to view and analyze the wish list of different buyers via the system match module 120 to configure packages and promotions that will have a high likelihood of attracting buyers.

The contemplated system of the invention utilizes data from the sellers or vendors 150 to verify that specific purchases occurred prior to issuing payments from the buyers. In the event that a refund for a purchase occurs, the system 100 notifies the seller or vendor 150 or a third party, and the buyer is then “marked” such that this buyer becomes excluded from receiving certain promotions or rewards. Alternatively, the rebate provided to the buyer is maintained in escrow for an extended period of time prior to being released to the buyer or it is credited against the buyer's account. In certain embodiments, transactions for less than a predetermined amount are treated differently than others. In other embodiments, certain product categories are also treated differently.

The system of the contemplated embodiments is provided with “back-end” links to the sellers or vendors to provide a way to capture order and shipping information via third party supply-chain software. Here, web services and xml transaction reporting is used to ensure that the system 100 is provided with the ability to control fraud and misuse of promotions. The system 100 may authorize and then deposit funds or, based on user instructions, route the funds to third party entities or providers.

FIG. 2 is a schematic block diagram illustrating the system match module 120 of FIG. 1. Users 210 and/or buyers 220 access the system match module 120 via a web site 200 that permits interfacing to a system match wish list 230, a search engine 240, a request entry module 250, a time frame determination module 260 and a price module 270 of the system.

The system match wish list 230 receives items located in the buyers' wish list (FIG. 1) that the buyer 220 may wish to purchase, as well as wish list items from users 210 and third party provider 290. For example, the buyer may transfer pertinent information, such as browsing history, from his own applications into the system match wish list database 230, which will be stored and indexed with respect to the buyer's wish list. Sellers or vendors 150 also upload wish list information to the system match wish list 230. In this case, however, the vendor wish list information comprises price and quantity limitations, such as packages of different items or quotes for lump sum promotions, which would be offered only if a predetermined quantity of a specific product would be sold to a specific buyer.

Search engine 240 performs searches for particular items or a particular area of interest related to the information stored into the system match wish list 230. Here, the buyer may proceed with a search for a particular item or within a particular area, which is then automatically stored by the system into that buyer's wish list. As a result, each time that the buyer performs a search regarding a particular item or a particular area of interest the information is stored into the buyer's wish list and/or the common wish list database 130 (FIG. 1).

Upon locating a match for a particular item or a particular area of interest, the request entry module 250 is used to receive a buyer or user request for the particular item or a particular area of interest. Time frame determination module 260 stores information related to modified requests for a particular item or information that is to be received at a later time when it may become available or when it matches the parameters defines in the wish list of the buyer. The time frame determination module 260 also provides parameters for determining the time period that coupons and reward programs are to remain valid for redemption. Placing a time limit on the validity of coupons and reward programs provides a way to ensure that they are utilized promptly and, thus, help to maximize the revenue stream of a vendor or third party provider.

The system match module 120 also includes a price module 270 that is used to provide a way for buyers to receive feedback from the system match module 120 that relates to the current possibility to acquire specific items based on a quoted price range. For example, if a quoted price range falls below a predetermined sale price set by the vendor 150 for a particular item, then the buyer is informed that the item is not available for the quoted price at this specific moment in time.

Data mining module 280 permits the system match module 120 to aggregate information pertaining to multiple requests from buyers and supplies this information to sellers or vendors 150 and other buyers. As a result, sellers or vendors 150 are permitted to arrange “attractive” package deals to market their goods and services. In accordance with the contemplated embodiments, the aggregated information includes key words, such as camera, memory cards or printers. For example, the seller or vendor 150 can assemble a package comprising a camera, a memory card, lens, filter and printer for a convenient lump sum. In addition, the vendor 150 may receive information related to the number of requests for a particular item and decide to supply the requested item to an existing number of buyers that request a discounted price or other special terms.

In association with a predetermined reward, the system match module 120 may alternatively send feedback to the requesting buyers and inform them how many more requests are needed to obtain the requested item for a discount or a particular connection with some reward. As a result, the requesting buyers may tell others about the rewards or discount and “pull” in the necessary number of additional buyers to obtain the requested item. In alternative embodiments, the aggregated information is used by vendors in conjunction with performing statistical predictions (e.g., customers interested in a first item will most likely be interested in another second item). Based on this information, the vendor 150 will assemble packages for enticing customers to make purchases. For example, a camera is requested and projections/forecasts indicate that customers interested in cameras are also interested in a tripod and a remote controller and, thus, the vendor puts together a package containing these three items for an attractive offer, such as obtain a discount if “you” purchase all or purchase the camera and obtain all the other items for free.

The data mining module 280 searches large volumes of data for patterns using tools, such as classification, association or clustering to provide information to seller or vendors 150. As a result, requests for identical items are compiled by data mining module 280, such as requests from men who like a particular type of cigar. Alternatively, a first item that customers are interested in is compiled with a second item, even though they could have no apparent connection, such as chocolates and flea collars for pets are combined together in an offer, or the items are combined based on statistical information.

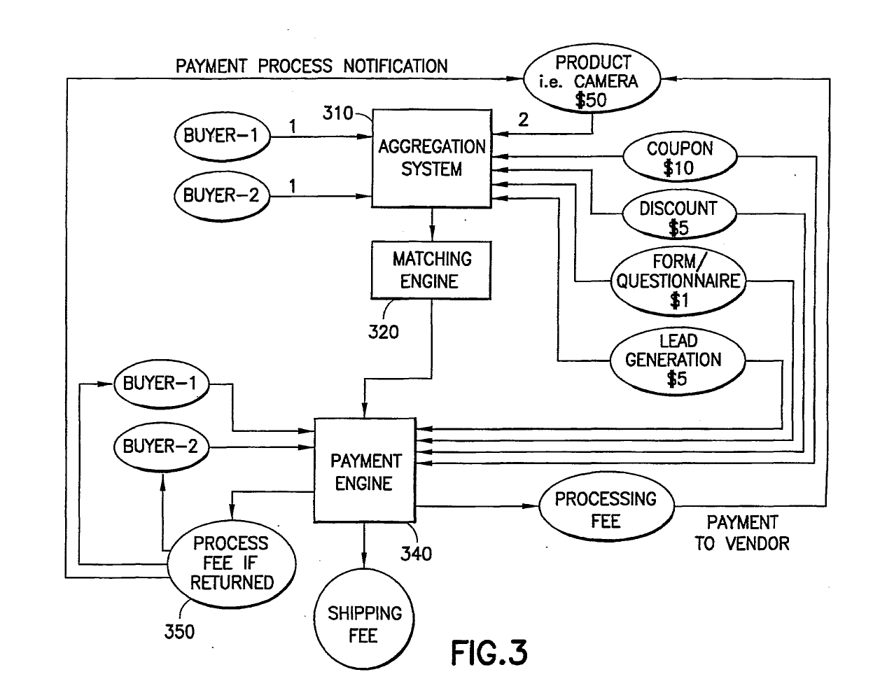

FIG. 3 is an exemplary block diagram illustrating the interaction of the components of the system match module 120 associated with providing notification of a payment in accordance with the invention. With reference to FIG. 3, if the buyer pursuant to interfacing with the system 100 purchases a $50 product, such as a camera, the payment engine performs account settlement. Payments from buyers and various applicable rewards, such as coupons, discounts, rewards for filling out forms/questionnaires or rewards for providing leads to other customers, are processed in the aggregation system 310. The shipping fees are deducted from the resultant amount, if and when applicable. A subsequent processing and shipping fee may be charged, and the new resultant amount will be paid to the vendor 150 (not shown). In the event where a refund is provided to the buyer, the process becomes reversed, i.e., the payment engine 340 receives from the vendor 150 the amount that was received for a particular item, and shipping charges are then credited to the buyer along with the processing fee. However, a new processing fee is charged for returning the payment to the buyer. Simultaneously, the processing fee if returned center 350 send a notification of the refund to the seller of the product.

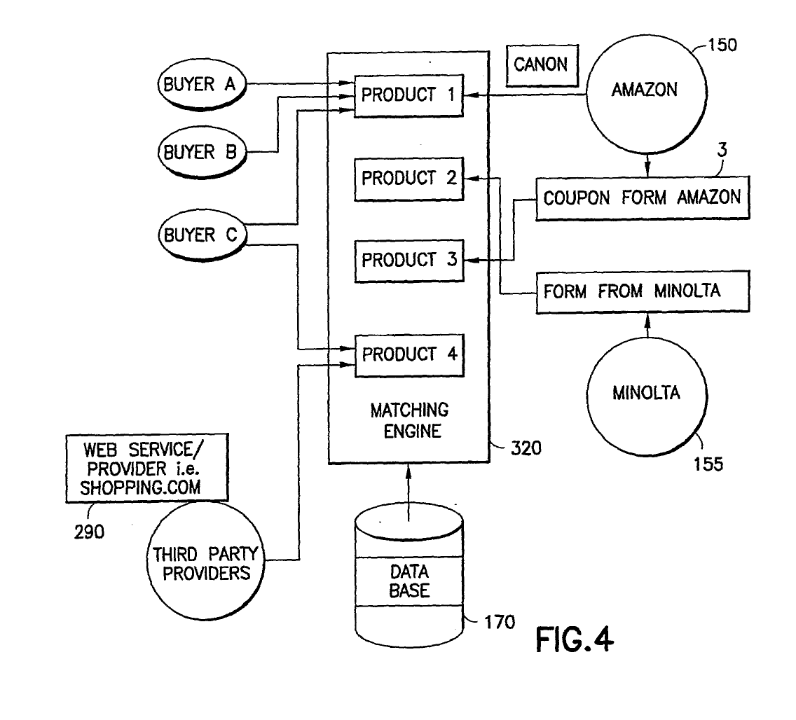

FIG. 4 is an exemplary block diagram illustrating the interaction of buyers and third party providers pursuant to placing orders for certain items. Here, buyers (e.g., Buyers A, B and C) and third party web service/providers 290 place requests for certain items, such as product 1, product 2, product 3 or product 4. The matching engine 320 matches requests for items or services with various discounts and rewards, such as a coupon from Amazon®, provided by sellers or vendors 150, manufacturers 155 (e.g., Minolta) and third party web service/distributors 290. In the event that no such rewards are available, the system sends the respective requests to vendors, informs them of the demands from buyer and permits vendors to make certain replacement offers to the buyers.

In addition, the system match module 120 is permitted to use the aggregation system 310 (see FIG. 3) to aggregate information so as to permit the generation of results that can be used by vendors to forecast and analyze market trends. As a result, the dynamic matching of supply and demand for specific items is provided. In addition, vendors 150 may conduct searches for different items and have the system provide existing and/or future projections of demand based on mining data accumulated by data mining module 280 (see FIG. 2).

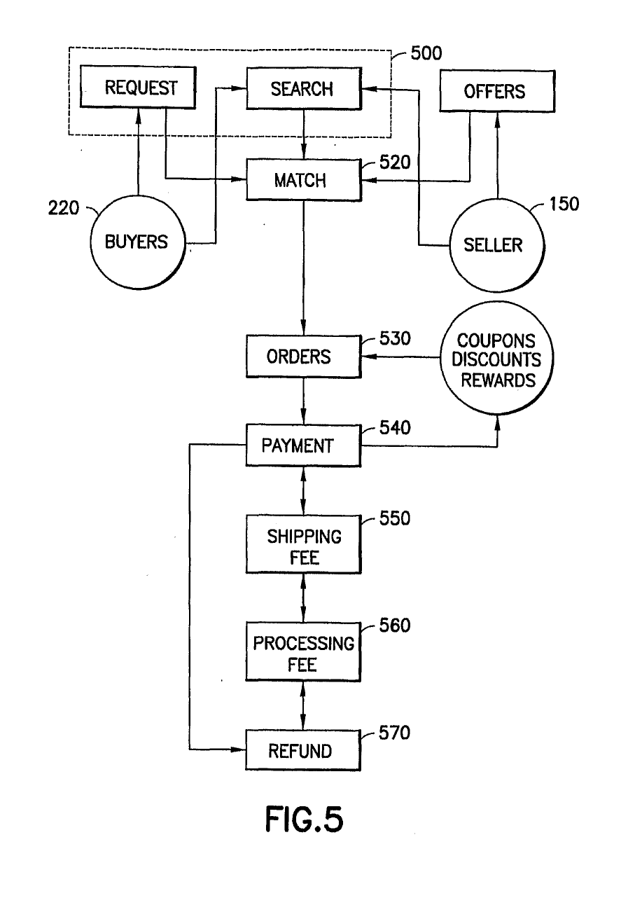

FIG. 5 is a flow chart illustrating the steps of the method of the invention associated with processing a transaction. A buyer accesses the portal 110 via a local device or the web to perform one of two steps, where the buyer may directly enter a request for a specific item or the buyer can request to perform a search for the specific item, as indicated in step 500. In an embodiment, the buyer is redirected to a third party search or seller web site or application. The portal via the system match module 120 monitors the transaction. In addition, the portal may be provided with one or several reports on the status of any transactions initiated by the buyer. In accordance with the method of the invention, the reports can be aggregated via several web services or provided directly to the system match module 120 by different sellers or vendors.

A result that matches the search or request from the buyer is then located, as indicated in step 520. The buyer then places an order for the identified item, as indicted in step 530. Here, the coupons or rewards that are associated with the specific item are processed, i.e. associated discounts and rewards from sellers or vendors are processed.

Next, the buyer receives an electronic payment directly from the system match module 120 or from a third party authorized to issue such payments, as indicated in step 340. Shipping fees associated with the product are then charged to the respective parties, as indicated in step 550. In addition, processing fees are also calculated and charged to the appropriate parties, as indicated in step 560.

Finally, in the event that a refund for a purchase occurs, the system 100 notifies the seller or vendor 150, and the buyer is then “marked” such that this buyer becomes excluded from receiving certain promotions, as indicated in step 570. Alternatively, the rebate provided to the buyer is maintained in escrow for an extended period of time prior to being released to the buyer.

The disclosed system and method provides a centralized system that acts on behalf of multiple merchants and provides a controlled and manageable way to monitor and issue rewards, discounts, coupons and payments to customers. Moreover, the system performs calculations to allocate discounts and rewards for individual buyers, designate final prices for individual buyers, and provide fast and efficient settlements of outstanding balances.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for locating rewards and discount coupons over the Internet, comprising:
accessing a portal via a local device;
entering one of a request for a specific item or a request to perform a search for the specific item;
monitoring transactions at the portal via a system match module;
locating a result that matches one of the entered search and request;
placing an order via the portal for an item identified by the search; and
receiving an electronic payment directly from the system match module based on coupons or discounts associated with the identified item.

2. The method of claim 1, further comprising:
charging shipping fees associated with the identified item;
calculating processing fees associate with the monitored transaction; and
charging the processing fees for the monitored transaction.

3. The method of claim 1, further comprising: sending a notification to a seller or vendor if a refund for a purchase occurs.

4. The method of claim 3, further comprising:
marking a buyer such that the buyer becomes excluded from receiving certain promotions if the refund for the purchase occurs.

5. The method of claim 4, further comprising:
maintaining the refund to the buyer in escrow for an extended period of time prior to being released to the buyer.

6. The method of claim 1, wherein said access of the portal comprises:
registering a buyer with the system match module via the portal; and
providing the registered buyer with multiple registration options.

7. The method claim 6, wherein a registration option comprises:
completing a document to indicate items or areas of interest for storage into a buyer wish list database.

8. The method of claim 6, wherein a registration option comprises:
transferring information into the system match module for storage into a buyer wish list database.

9. The method of claim 8, wherein the transferred information comprises browsing history of the buyer.

10. The method of claim 6, wherein a registration option comprises:
searching for the specific item within a particular area;
storing the result that matches the searched item in a buyer wish list database.

11. The method of claim 7, further comprising:
obtaining consent from the buyer to have their information loaded or stored in a common wish list database.

12. The method of claim 8, further comprising:
obtaining consent from the buyer to have their information loaded or stored in a common wish list database.

13. The method of claim 10, further comprising:
obtaining consent from the buyer to have their information loaded or stored in a common wish list database.

14. The method of claim 11, wherein the buyer wish list database and the common wish list database contain information of immediate concern or information that relates to acquiring items in the future.

15. The method of claim 12, wherein the buyer wish list database and the common wish list database contain information of immediate concern or information that relates to acquiring items in the future.

16. The method of claim 13, wherein the buyer wish list database and the common wish list database contain information of immediate concern or information that relates to acquiring items in the future.

17. A system for locating rewards and discount coupons over the Internet, comprising:
a portal, said portable being accessed via a local device;
a system match module for monitoring transaction at the portal;
at least one buyer wish list data base for storing items or areas of interest for individual buyers;
at least one vendor wish list database for storing price and quantity limitation for items of interest associated with the discount coupons; and
a repository database for storing the discounts and coupons associated with the items of interest.

18. The system of claim 17, further comprising:
a common wish list database for storing wish list information of multiple buyers.

19. The system of claim 17, wherein the system match module comprises a system match wish list, a search engine, a request entry module, a time frame determination module and a price module.

20. The system of claim 19, wherein the system match wish list receives items located in the at least one buyer wish list database that the at least one buyer may wish to purchase and wish list items from users and third party providers.

21. The system of claim 19, wherein the search engine performs searches for the items or the areas of interest related to information stored into the system match wish list.

22. The system of claim 19, wherein the request entry module receives a buyer or user request for the item or an area of interest upon locating a match for the item or the area of interest.

23. The system of claim 19, wherein the time frame determination module stores information related to modified requests for the items or information that is to be received at a later time.

24. The system of claim 19, wherein the time frame determination module provides parameters for determining the time period that the discount coupons and rewards are to remain valid for redemption.

25. The system of claim 19, wherein the price module provides a way for buyers to receive feedback from the system match module that relates to a current possibility to acquire items based on a quoted price range.

26. The system of claim 19, wherein the data mining module permits the system match module to aggregate information pertaining to multiple requests from buyers and supplies this information to sellers or vendors.

27. The system of claim 19, wherein the system match module further comprises a matching engine for matching requests for items or services with various discounts and rewards, an aggregation system for processing payments from buyers and various applicable rewards, a payment engine for issuing payments and credits to the at least one buyers and the at least one vendor and a processing fee if returned center for sending a notification of a refund to the seller of the item.

28. The system of claim 27, wherein the individual buyer is marked such that the buyer becomes excluded from receiving certain promotions if the refund to the seller of the item occurs.
